(19) United States
(12) Patent Application Publication
(10) Pub. No.: US 2020/0290079 A1
(43) Pub. Date: Sep. 17, 2020

(54) NOZZLE ARRANGEMENT FOR APPLYING FLUIDS, SYSTEM HAVING SUCH A NOZZLE ARRANGEMENT, AND METHOD FOR APPLYING FLUIDS

(71) Applicant: Illinois Tool Works Inc., Glenview, IL (US)

(72) Inventor: Andreas Pahl, Erkrath (DE)

(73) Assignee: Illinois Tool Works Inc., Glenview, IL (US)

(21) Appl. No.: 16/814,500

(22) Filed: Mar. 10, 2020

(30) Foreign Application Priority Data
Mar. 11, 2019 (DE) 10 2019 106 146.6

(51) Int. Cl. B05C 5/02; B05B 7/08

(52) U.S. Cl. CPC B05C 5/0279; B05B 7/0884; B05C 5/0254; B05B 7/0861; B05C 5/0237

(57) ABSTRACT

A nozzle arrangement applies fluids, in particular thermoplastic adhesives, to a substrate. The nozzle arrangement and the substrate move relative to one another in a first direction. The nozzle arrangement has a main body which is exchangeably connected to a mounting region of a distributor and which has an end-side side surface extending in a second direction running at least substantially perpendicular to the first direction. The end-side side surface of the main body can have mutually adjacently arranged first outlet nozzles for the fluid to be applied formed in a first row extending along the second direction and mutually adjacently arranged second outlet nozzles for a second fluid formed in a second row extending along the second direction and that is parallel to the first row.

### CROSS-REFERENCE TO RELATED APPLICATIONS

This application claims priority to DE patent application 10 2019 106 146.6 pursuant to 35 U.S.C. § 119 and 37 C.F.R. § 1.55, which was filed on 11 Mar. 2019, and the entire disclosure of which is incorporated herein by reference.

### BACKGROUND

### Technical Field

The inventive subject matter described herein relates in general to the application of fluids, including thermoplastic or fibrous adhesives, to a substrate by at least one nozzle arrangement, which is fastened, preferably detachably, to a mounting surface of a distributor or a distributor head. This distributor or distributor head is generally used to supply the fluid to be applied suitably to the at least one nozzle arrangement.

The purpose of such a system is the application of fluids to, for example, substrates moving relative to the at least one nozzle arrangement, and in particular the application of adhesives in partial spray patterns to partially cover a substrate.

### Discussion of Art

Document EP 0 872 580 A, for example, discloses a plurality of melt blowing nozzle arrangements or nozzles, which can be fastened side to side on one or both ends of a conventional distributor or distributor head, which ensures a metered supply of adhesive to each nozzle arrangement. The nozzle arrangements each comprise a plurality of substantially parallel plate elements, which are formed on an outlet surface. The row of fluid outlet openings of each nozzle arrangement forms a section of a longer row, which is formed by the plurality of adjacent nozzle arrangements arranged along a common end of the distributor head. One or both sides of the distributor can be fastened adjacent to the side of a similarly constructed distributor head to form even longer rows of fluid outlet openings, whereby a modular melt blowing adhesive dispenser system is provided, which accommodates substrate having any dimensional width.

In some adhesive-dispensing applications, it is desirable for the adhesive to be applied to a substrate in such a way that it covers the full width of the substrate as completely as possible. These applications include, for example, the application of adhesives during the production of vehicle interior trim parts, and in particular in the case of the application of adhesives to the lower side of a decorative layer or to a substrate to which a decorative layer is to be adhesively bonded. The adhesive is typically applied to the so-called “carrier part” (in particular a plastic injection-molded part), and then the part is laid in a device for press lamination. The adhesive can be reactivated via IR light, and the carrier part can then be compressed with a decorative blank.

For such applications, it is necessary in particular for the adhesive to be applied as uniformly and homogeneously as possible, since under certain circumstances an irregular adhesive application can have negative effects on the visual appearance of the fastened decorative layer or negative effects on the haptics. In particular a fine spray pattern without tracks is desired during the adhesive application, wherein above all there cannot be droplet formation in the pattern.

For reasons of perspective, a conventional system 150 for applying thermoplastic adhesives 20 on a substrate 21 is shown schematically and in an isometric view in FIG. 1. The system 150 substantially consists of a distributor head 30, which is preferably connected or can be connected to an actuator (not shown in FIG. 1), for example, a robot arm or the like, and which can be moved along a direction of movement relative to the substrate 21.

A nozzle arrangement 101 is connected, preferably exchangeably, to the distributor head 30 in a mounting region of the distributor head 30. The distributor head 30 is used in this case to supply the nozzle arrangement 101 with the thermoplastic adhesive 20 to be sprayed and possibly other fluids, for example, shaping air, etc., in a suitable manner.

The nozzle arrangement 101 used in the conventional system 150 for applying thermoplastic adhesives 20 to a substrate 21 is, for example, a so-called UFDTM nozzle arrangement of the present applicant, by means of which a random application pattern can be applied to the substrate 21. Such a nozzle arrangement is described—at least in principle—in the above-mentioned document EP 0 872 580 A.

Briefly summarized, this application describes a nozzle arrangement 101 having a main body 102, which—seen in a top view—is embodied to be at least substantially perpendicular, and which is connected or can be connected to the mounting region of the distributor head 30.

The main body of the nozzle arrangement 101 has an end-side side surface, which corresponds to the outlet surface via which the thermoplastic adhesive 20 to be applied to the substrate 21 is dispensed.

To be able to apply the adhesive 20 as flatly as possible to the substrate 21, a multiplicity of adjacently arranged outlet nozzles for the adhesive to be applied is formed in the end-side side surface of the main body, which extends in a direction extending perpendicularly to the direction of movement of the distributor head 30. To be able to image a defined application pattern of the adhesive 20 on the substrate 21, corresponding outlet nozzles for shaping air are associated with the individual outlet nozzles for the adhesive 20 to be applied.

It is provided in particular for this purpose in the known nozzle arrangement 101 that, in the extension direction of the end-side side surface of the main body, first outlet nozzles for the adhesive 20 to be applied, on the one hand, and second outlet nozzles for corresponding shaping air (in particular pressurized air), on the other hand, are arranged adjacent and in particular alternating. The (second) outlet nozzles for shaping air are designed to form a multiplicity of shaping air fluid streams, which are particularly oriented converging, specifically with respect to adhesive fluid streams which are oriented from the first outlet nozzles for the adhesive 20 to be applied to the substrate 21. The adhesive fluid stream which is dispensed from the individual first outlet nozzles for the adhesive 20 can be deflected by variation of the quantity dispensed per unit of time from the second outlet nozzles of shaping air or pressurized air.

Although the distributor heads 30 and/or nozzle arrangements 101 known from the prior art are capable of applying the adhesive 20 flatly and with a defined application pattern to the substrate 21, the nozzle arrangements 101 known from the prior art have certain limits in the applications thereof. This applies in particular to those applications in which the flattest possible adhesive application to the substrate 21 and in particular the most uniform possible adhesive application to the substrate 21 is required, as is desired, for example, in the case of laminating decorative surfaces, in particular onto interior trim parts for vehicles.

### BRIEF DESCRIPTION

On the basis of this statement of the problem, the underlying object of the inventive subject matter is thus to refine a nozzle arrangement of the type mentioned at the outset in such a way that a finer adhesive application pattern on the substrate is optionally achievable, where the flattest possible adhesive application is desired, simultaneously.

In addition, a corresponding optimized system for applying fluids, in particular thermoplastic adhesives, to a substrate and an optimized method for applying fluids, in particular thermoplastic adhesives, to a substrate are to be specified.

The underlying object of the inventive subject matter is achieved with regard to the nozzle arrangement by the subject matter of independent Patent claim 1.

The underlying object of the inventive subject matter is achieved with regard to the system by the subject matter of concurrent Patent claim 12 and with regard to the method by the subject matter of concurrent Patent claim 13, wherein advantageous refinements of the inventive subject matter are each specified in the corresponding dependent claims.

The inventive subject matter accordingly relates in particular to a nozzle arrangement for applying fluids, in particular thermoplastic adhesives, to a substrate, wherein the nozzle arrangement and the substrate move relative to one another in a first direction (=direction of movement). In this case, for example, the substrate can be moved relative to the fixed nozzle arrangement or also the nozzle arrangement can be moved relative to the fixed substrate.

The nozzle arrangement has a main body which is able to be connected, preferably exchangeably, to a mounting region of a distributor, in particular to a mounting region of a distributor head, and which has an end-side side surface. The distributor or distributor head can be fastened, for example, on an actuator, for example, a robot arm or the like, to move the nozzle arrangement relative to the substrate.

The end-side side surface of the main body extends at least substantially in a second direction, which runs at least substantially perpendicularly to the first direction, i.e., the (relative) direction of movement.

It is provided in particular according to the inventive subject matter that, in the end-side side surface of the main body, a multiplicity of mutually adjacently arranged first outlet nozzles for the fluid to be applied (in particular adhesive) is formed, specifically in a first row extending along the second direction. In addition to the first outlet nozzles extending along a first row, a multiplicity of mutually adjacently arranged second outlet nozzles for a second fluid is provided, wherein the second outlet nozzles are formed in a second row extending along the second direction. It is provided in this case that the second row along which the second outlet nozzles are formed runs parallel to the first row along which the first outlet nozzles are formed.

The advantages achievable by the solution according to the inventive subject matter include: in that according to the inventive subject matter an alternating arrangement of first outlet nozzles for the adhesive to be applied to the substrate and second outlet nozzles for the shaping air is intentionally omitted, and all outlet nozzles for the adhesive (=first outlet nozzles) are arranged along a row and directly mutually adjacent, it is possible with identical dimensions of the nozzle arrangement to house a significantly higher number of first outlet nozzles for the adhesive to be applied (=first outlet nozzles) in the end-side side surface of the main body of the nozzle arrangement.

It is furthermore advantageous that a deflection/oscillation of the adhesive or filament jets dispensed by the first outlet nozzles only takes place with respect to the center of gravity in the direction of movement of the robot or the nozzle arrangement. The oscillation in the transverse direction of the nozzle arrangement is thus reduced and fusing of multiple adjacent filament jets is thus prevented, which is a known problem in particular in the case of nozzles having a close spacing of the adhesive openings according to the prior art. Moreover, the edge sharpness of the application can be improved, since a transverse oscillation is always detrimental here and produces a fuzzy edge.

Using the nozzle arrangement according to the inventive subject matter, a targeted deflection of the adhesive fluid jets dispensed by the first outlet nozzles is nonetheless possible, since a second row with outlet nozzles for a second fluid, in particular shaping air or the like, is formed parallel to the (first) row along which the first outlet nozzles are arranged.

Due to this parallel arrangement of the first outlet nozzles for the adhesive to be applied, on the one hand, and the second outlet nozzles for the shaping air, on the other hand, a significantly finer application pattern of the adhesive on the substrate is implementable since—in contrast to the above-described nozzle arrangements known from the prior art—in particular also a deflection of the adhesive fluid jets dispensed by the first outlet nozzles in the first direction, i.e., in the (relative) direction of movement, is also possible using the second outlet nozzles.

Therefore, at the same dimension of the nozzle arrangement, a particularly compact system can be provided, which is capable of applying adhesive for such a fluid particularly uniformly and flatly onto the substrate, which is desirable in particular if a decorative layer is to be applied with the aid of an adhesive layer to a substrate.

To achieve the most targeted possible deflection of the fluid jets dispensed by the first outlet nozzles, it is provided in particular that for each first outlet nozzle, at least one and preferably precisely one second outlet nozzle is provided, which is spaced apart from the first outlet nozzle in the first direction (=(relative) direction of movement).

In particular, it is provided according to embodiments of the nozzle arrangement according to the inventive subject matter that in each case one second outlet nozzle is arranged perpendicularly to a first outlet nozzle with respect to the second direction.

To be able to implement the finest possible application patterns of the adhesive on the substrate using the nozzle arrangement according to the inventive subject matter, it is provided in one preferred implementation of the nozzle arrangement according to the inventive subject matter that, in the end-side side surface of the main body, a multiplicity of mutually adjacently arranged third outlet nozzles for a fluid, in particular for the second fluid, is furthermore formed in a third row extending along the second direction, wherein the first row, with the first outlet nozzles, for the fluid (in particular adhesive) to be applied to the substrate, is arranged between the second and third rows, with the second and third outlet nozzles.

It also suggests itself in this refinement of the nozzle arrangement according to the inventive subject matter that, for each first outlet nozzle, at least one and also preferably precisely one third outlet nozzle is provided, which is spaced apart from the first outlet nozzle in the first direction (=(relative) direction of movement).

According to embodiments of the nozzle arrangement according to the inventive subject matter it is provided in particular that the effective surface of each nozzle opening of the first nozzle is preferably of an equal size or at least substantially of an equal size. In this manner, a uniform fluid application onto the substrate can be achieved over the extension direction (second direction) of the nozzle arrangement.

Alternatively or additionally thereto, the effective surface of the respective nozzle openings of the first outlet openings are in particular to be larger in size than the effective surface of the respective nozzle openings of the second and/or third outlet nozzles. In this manner, the fluid jets dispensed by the second and/or third outlet nozzles can effectively assume a high flow speed, to thus reduce the static pressure in the vicinity of these fluid jets, which has a direct influence on a deflection of the fluid jets dispensed by the first outlet nozzles.

In other words, the range and the extent of the achievable deflections of the fluid jets dispensed by the first outlet nozzles is optimized by this embodiment in a way which is particularly easy to implement but nonetheless effective.

According to preferred embodiments—as viewed in the longitudinal direction of the end-side side surface—the length extent of each nozzle opening of the first outlet nozzle is smaller than the length extent of the nozzle openings of the second and/or third outlet nozzles. Alternatively or additionally thereto, it is provided that—as viewed in the transverse direction of the end-side side surface—the length extent of each nozzle opening of the first nozzle is greater than the length extent of the nozzle openings of the second and/or third outlet nozzles.

In other words, in the nozzle arrangement, the air openings are preferably wider than the adhesive openings to cover the adhesive filament well with an air jet. For this purpose, the air channels/air openings are kept narrower than the adhesive channel/adhesive openings, to achieve a high air exit speed, which is important for a high oscillation frequency and for a fine spray picture.

In preferred embodiments of the nozzle arrangement according to the inventive subject matter, the first outlet nozzles are formed for dispensing a first fluid, which is preferably the fluid (adhesive) to be applied, in the form of first fluid streams. Furthermore, it is preferably provided that the second outlet nozzles are formed for dispensing a second fluid, which is preferably a gas, in particular pressurized air, in the form of second fluid streams such that each second fluid stream runs at least substantially parallel to a first fluid stream.

In this configuration, influencing the direction of the first fluid stream by way of a variation of the flow speed of the second fluid stream is possible, since at a higher flow speed the static pressure decreases according to Bernoulli's law and thus the first fluid stream is deflected in the direction of the second fluid stream.

Alternatively thereto, it is obviously also conceivable that the second outlet nozzles are formed to dispense the second fluid (in particular pressurized air) in the form of second fluid streams such that each second fluid stream converges with a first fluid stream.

In the figurative sense, this also obviously applies to the third outlet nozzles, which are preferably formed such that a fluid, which is preferably a gas, in particular pressurized air, is dispensed in the form of third fluid streams from the third outlet nozzles. In this case, each third fluid stream can run at least substantially parallel to a first fluid stream. Alternatively thereto, however, it is also conceivable that each third fluid stream converges with a first fluid stream.

According to preferred implementations of the nozzle arrangement according to the inventive subject matter, the first outlet nozzles are formed for dispensing the first fluid, which is preferably the fluid to be applied, in each case at an equal first fluid mass flow rate. Furthermore, the second outlet nozzles are preferably formed for dispensing the second fluid in each case at an equal second fluid mass flow rate, and the third outlet nozzles are formed for dispensing the fluid in each case at an equal third fluid mass flow rate.

In this embodiment, it is conceivable if the second and third fluid mass flow rates are selected to be equal. However, it is advantageous to achieve a particularly fine deflection of the (first) fluid streams dispensed by the first outlet nozzles if the second and third fluid mass flow rates are different from one another and in particular vary with respect to time.

To achieve the most compact possible structural form of the nozzle arrangement, according to embodiments of the nozzle arrangement according to the inventive subject matter, it is in the form of a laminated nozzle assembly which consists of a multiplicity of sheet-like elements which are flatly connected with one another. Of course, other embodiments also come into consideration here.

The inventive subject matter furthermore relates to a system for applying fluids, in particular thermoplastic adhesives, to a substrate. The system according to the inventive subject matter has a distributor head, which is preferably connected or able to be connected to an actuator, in particular in the form of a robot arm. In particular, it is provided in this case that the distributor head is able to be moved relative to the substrate along a direction of movement.

The system according to the inventive subject matter furthermore has at least one nozzle arrangement of the type according to the inventive subject matter, which is connected, preferably exchangeably, to the distributor head in a mounting region of the distributor head.

It is provided in particular in the system according to the inventive subject matter that the at least one nozzle arrangement is arranged in the mounting region of the distributor head such that the end-side side surface of the main body of the nozzle arrangement is oriented at least substantially perpendicular to the direction of movement of the distributor head. The direction of movement of the distributor head corresponds in this case to the direction along which the distributor head is moved when fluids are applied via the first outlet nozzles of the nozzle arrangement.

The nozzle arrangement is preferably formed as a laminated nozzle assembly which consists of a multiplicity of sheet-like elements which are flatly connected to one another. The formation of the nozzle assembly as a laminated nozzle assembly has the advantage that complex fluid channel systems can also be designed in the interior of the main body particularly precisely but nonetheless in a relatively simple manner.

In other words, even complex fluid channels and/or fluid channel systems can be readily integrated into the nozzle arrangement. These fluid channels can be fluidically connected via a corresponding interface region to corresponding associated fluid channels in the mounting region of the distributor head.

The design of the nozzle arrangement according to the inventive subject matter as a laminated nozzle assembly thus overall enables a compact nozzle arrangement in which all necessary functionalities are integrated.

Alternatively thereto, however, it is also conceivable to produce the nozzle arrangement according to the inventive subject matter by means of three-dimensional (3D) printing. The laser sintering method or micro-laser sintering, also called selective laser melting SLM (selective laser melting metal), can be used in particular here. By way of these manufacturing methods, the fluid channels can also be embodied as curved in multiple planes in order to achieve perfect flows. Mounting of the nozzle is dispensed with and therefore any possible mounting errors and tolerance deviations due to the mounting are also.

According to a further aspect of the present inventive subject matter, it is provided that the fluid, and in particular the thermoplastic adhesive, can be dispensed according to a previously established event sequence using the nozzle arrangement, and in particular using the first outlet nozzles. The nozzle arrangement according to the inventive subject matter is suitable in particular for the purpose of dispensing the fluid (the thermoplastic adhesive) using a pattern, and in particular using an oscillating pattern.

With regard to the method according to the inventive subject matter for applying fluids, and in particular thermoplastic adhesives, to a substrate it is provided that a nozzle arrangement is moved relative to the substrate in a direction of movement, where this nozzle arrangement is in particular a nozzle arrangement of the above-described type according to the inventive subject matter.

In the method according to the inventive subject matter, it is furthermore provided that fluid jets, in particular thermoplastic adhesive jets, are dispensed through the first outlet nozzles of the nozzle arrangement during the movement relative to the substrate.

These fluid jets dispensed by the first outlet nozzles can be deflected, for example, with the aid of shaping air dispensed via the second and/or third outlet nozzles, in particular periodically from the main flow axis, in particular for the purpose of creating an omega-shaped pattern of the fluid jet to be applied to the substrate.

Example embodiments of the nozzle arrangement according to the inventive subject matter are described in greater detail hereafter with reference to the appended drawings.

### BRIEF DESCRIPTION OF THE DRAWINGS

In the figures:

FIG. 1 shows, schematically and in an isometric view, a conventional system for applying thermoplastic adhesives to a substrate;

FIG. 2 shows, schematically and in an isometric view, an example embodiment of the nozzle arrangement according to the inventive subject matter;

FIG. 3 schematically shows a frontal view of the example embodiment of the nozzle arrangement according to the inventive subject matter according to FIG. 2 on the end-side side surface of the main body of the nozzle arrangement;

FIG. 4 shows an enlarged detail from FIG. 3, which is indicated in FIG. 3 by the circle identified by “A”;

FIG. 5 schematically shows the example embodiment of the nozzle arrangement according to the inventive subject matter in an exploded illustration;

FIG. 6 shows an enlarged detail from FIG. 5, which is indicated in FIG. 5 by the circle identified by “A”;

FIG. 7 schematically shows a frontal view of a further example embodiment of the nozzle arrangement according to the inventive subject matter on the end-side side surface of the main body of the nozzle arrangement; and

FIG. 8 shows an enlarged detail from FIG. 7, which is indicated in FIG. 7 by the circle identified by “A”.

### DETAILED DESCRIPTION

It has been recognized for some time that thermoplastic adhesives 20 form good binders. This is because they cure rapidly, which is a particular advantage if the adhesive 20 is applied step-by-step and the bond of the parts to be adhesively bonded then takes place immediately, and the obtained adhesive bond is very strong. Furthermore, the selection of components from which thermoplastic adhesives 20 may be composed is sufficiently large that a corresponding adhesive composition can be produced easily for a given purpose.

Nonetheless, obstacles have arisen in the expanded usage of these adhesives 20 insofar as the thermoplastic adhesive 20 may sometimes be applied not at all or only with greater difficulties in an automated manner to specific, selected regions of a substrate 21, in particular having a complex geometry.

This also applies to applications in which, for example, decorative materials are to be applied to a substrate 21 of an interior trim part of a vehicle via an adhesive bond. In such applications, the risk exists in principle that the adhesive bond between the decorative layer, on the one hand, and the substrate 21, on the other hand, is still visible/recognizable and/or haptically perceptible from the visible side (=A side) of the interior trim part, in particular if the adhesive layer was not applied flatly enough and uniformly enough to the substrate 21 and/or the decorative layer.

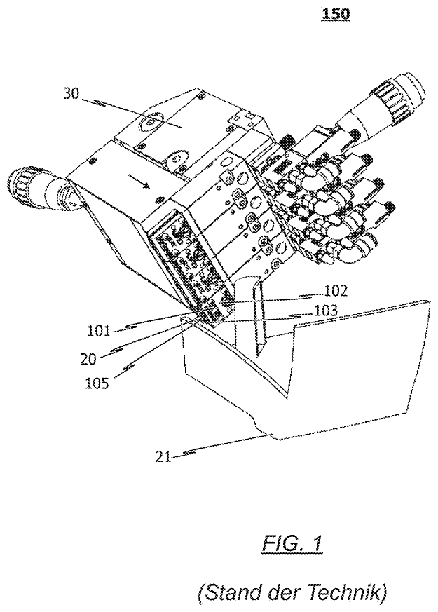

A conventional system 150 is shown schematically and in an isometric view in FIG. 1, using which a thermoplastic adhesive 20 is applied in an automated manner to specific regions of a substrate 21 formed as a molded part. The conventional system 150 for applying thermoplastic adhesives 20 to a substrate 21 formed as a molded body has a distributor head 30, which is preferably connected or can be connected to a robot arm (not shown in FIG. 1) or such an actuator and which can be moved with the aid of the robot arm/actuator along a direction of movement relative to the substrate 21.

As shown in FIG. 1, the conventional system 150 for applying thermoplastic adhesives 20 has a nozzle arrangement 101, which is connected, preferably exchangeably, to the distributor head 30 in a mounting region of the distributor head 30. This nozzle arrangement 101 is substantially formed by an approximately rectangular main body 102, via which the nozzle arrangement 101 is connected to the mounting region of the distributor head 30.

This substantially rectangular main body 102—as viewed in a top view—of the nozzle arrangement 101 has an end-side side surface 103, in which a multiplicity of outlet nozzles 105 is formed. The main flow axes predetermined by the outlet nozzles 105 or the outlet openings of the outlet nozzles 105, along which the thermoplastic adhesive material 20 dispensed by the outlet nozzles 105 move, substantially enclose a right angle with the end-side side surface 103 of the main body 102 of the nozzle arrangement 101. Furthermore, the end-side side surface 103 of the main body 102 is oriented in the direction of movement of the distributor head 30.

To be able to form an application pattern of the adhesive 20 on the substrate 21 in the case of the conventional nozzle arrangement 101, both (first) outlet nozzles for the adhesive 20 to be applied, on the one hand, and (second) outlet nozzles for shaping air, on the other hand, are arranged alternating and in a row in the end-side side surface of the main body.

However, this structure only has limited suitability for certain applications, in which the flattest and most uniform possible application of the adhesive to the substrate 21 is important.

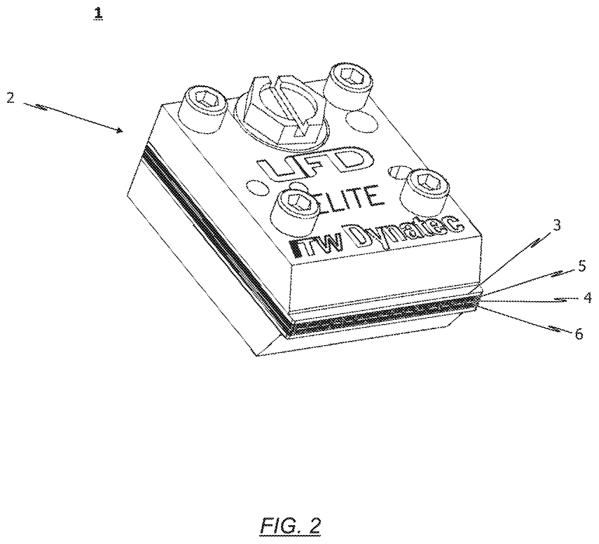

An optimized nozzle arrangement 1 is therefore proposed according to the inventive subject matter, where an example embodiment of this nozzle arrangement 1 is described in greater detail hereafter with reference to the illustration in FIGS. 2 to 6.

The nozzle arrangement 1 according to the inventive subject matter, as shown by way of example in FIGS. 2 to 6, has a main body 2, which can be connected, preferably exchangeably, to a mounting region of a distributor 30 or distributor head.

The main body 2 can have, for example, an at least substantially rectangular configuration having an end-side side surface 3. This end-side side surface 3 extends in a direction which, in operation of the nozzle arrangement 1, i.e., when the nozzle arrangement 1 is used to apply fluids 20 to a substrate 21, runs at least substantially perpendicularly to the direction in which the substrate 21 is moved relative to the nozzle arrangement 1.

In the end-side side surface 3 of the main body, a multiplicity of mutually adjacently arranged first outlet nozzles 4 for the fluid 20 to be applied to the substrate 21 is formed. The first outlet nozzles 4 are arranged in a first row extending along the longitudinal direction of the end-side side surface 3.

Furthermore, a multiplicity of mutually adjacently arranged second outlet nozzles 5 for a second fluid is provided. The second outlet nozzles 5 are formed in a second row extending along the longitudinal direction of the end-side side surface 3 of the main body 2.

As can be inferred in particular from the illustration in FIG. 3, the second row with the second outlet nozzles 5 runs parallel to the first row with the first outlet nozzles 4.

In the end-side side surface 3 of the main body 2, furthermore a multiplicity of mutually adjacently arranged third outlet nozzles 6 for a fluid, in particular a fluid which also flows via the second outlet nozzles 5, is formed. Specifically, the third outlet nozzles 6 are formed in a third row extending along the longitudinal direction of the end-side side surface 3 of the main body 2. It is provided in this case that the first row with the first outlet nozzles 4 is arranged between the second and third rows with the second and third outlet nozzles 6.

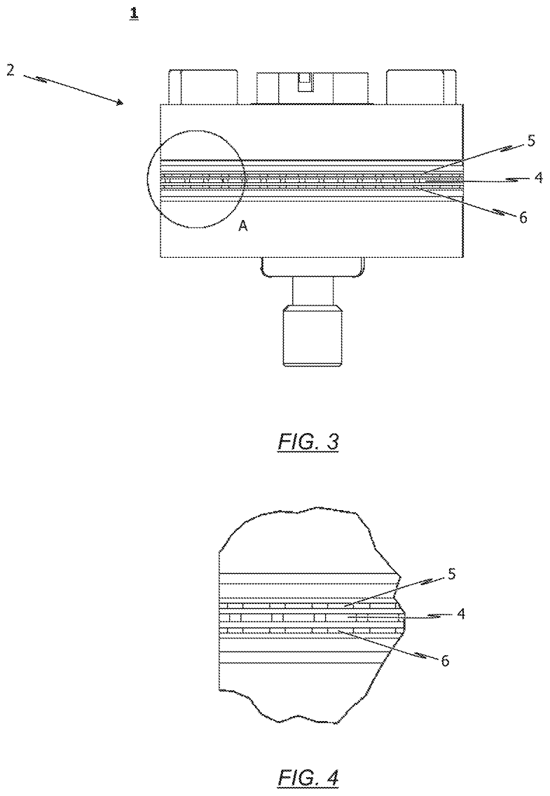

As can be inferred in particular from the partial view in FIG. 4, precisely one second and precisely one third outlet nozzle 5, 6, which are each spaced apart from the first outlet nozzle 4 in a direction perpendicular to the longitudinal direction of the end-side side surface 3 of the main body 2, are provided for each first outlet nozzle 4.

It can furthermore be inferred from the detail view of FIG. 4 that the effective surface of each nozzle opening of the first outlet nozzles 4 is of an equal size. In addition, the effective surface of each nozzle opening of the first outlet nozzle is preferably larger in size than the effective surface of each nozzle opening of the first and second outlet nozzles 5, 6.

The first nozzles 4 are formed in particular for dispensing a first fluid 20, which is preferably the fluid to be applied to the substrate 21, in the form of first fluid streams.

In the same manner, the second and third outlet nozzles 5, 6 are formed for dispensing a second fluid, which is preferably a gas, in particular compressed air, in the form of second and third fluid streams such that each second and third fluid stream runs at least substantially parallel to a first fluid stream dispensed by a first outlet nozzle 4 or converges with the first fluid stream.

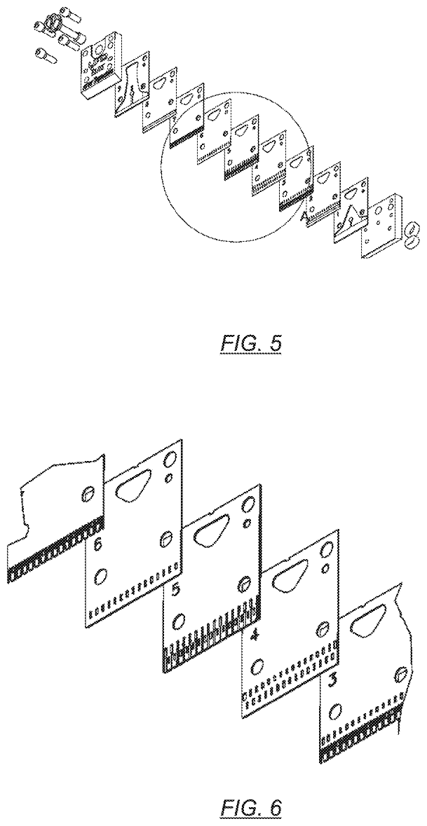

It can be inferred from the illustration in FIGS. 5 and 6 that the nozzle arrangement 1 can be formed as a laminated assembly which consists of a multiplicity of sheet-like elements which are flatly connected to one another.

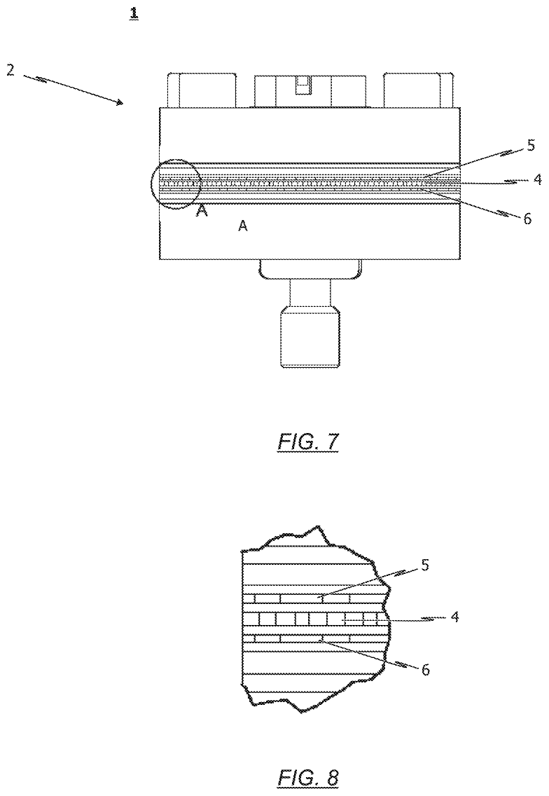

FIG. 7 schematically shows a frontal view of a further example embodiment of the nozzle arrangement 1 according to the inventive subject matter on the end-side side surface 3 of the main body 2 of the nozzle arrangement 1, while FIG. 8 shows an enlarged detail from FIG. 7, which is indicated in FIG. 7 by the circle identified by “A”.

On the basis of the illustrations of this example embodiment of the nozzle arrangement 1 according to the inventive subject matter, it is apparent that—as viewed in the longitudinal direction of the end-side side surface 3—the length extent of each nozzle opening of the first outlet nozzle 4 is smaller than the length extent of the nozzle openings of the second and/or third outlet nozzles 5, 6.

Furthermore, it is apparent that—as viewed in the transverse direction of the end-side side surface 3—the length extent of each nozzle opening of the first outlet nozzle 4 is greater than the length extent of the nozzle openings of the second and/or third outlet nozzles 5, 6.

In other words, in the nozzle arrangement 1 according to FIG. 7 and FIG. 8, the air openings are preferably wider than the adhesive openings to cover the adhesive filament well with an air jet. For this purpose, the air channels/air openings are kept narrower than the adhesive channels/adhesive openings to achieve a high air exit speed, which is important for a high oscillation frequency and for a fine spray picture.

The inventive subject matter is not restricted to the example embodiments shown in the drawings, but rather results from a consideration together of all features disclosed herein.

1. A nozzle arrangement for applying fluids first and second fluids to a substrate, wherein the nozzle arrangement and the substrate move relative to one another in a first direction, the nozzle arrangement including:
a main body configured to be connected to a mounting region of a distributor and which has an end-side side surface which extends in a second direction, which runs at least substantially perpendicular to the first direction,
wherein the end-side side surface of the main body includes mutually adjacently arranged first outlet nozzles for the first fluid to be applied is formed in a first row extending along the second direction,
wherein the end-side side surface of the main body includes mutually adjacently arranged second outlet nozzles for the second fluid is furthermore formed in a second row extending along the second direction,
wherein the second row runs parallel to the first row.

2-4. (canceled)

5. The nozzle arrangement of claim 1,
wherein each of the first outlet nozzles and each of the second outlet nozzles has a nozzle opening with an effective surface of each of the nozzle openings of the first outlet nozzles being an equal size or at least substantially of an equal size to each other, and wherein the nozzle openings of the first outlet nozzles are larger than an effective surface of each of the nozzle openings of the second and/or third outlet nozzles.

6. The nozzle arrangement of claim 1,
wherein each of the first outlet nozzles and each of the second outlet nozzles has a nozzle opening, wherein a length of each of the nozzle openings of the first outlet nozzles is smaller than a length of each of the nozzle openings of the second outlet nozzles.

7. (canceled)

8. The nozzle arrangement of claim 1,
wherein the first outlet nozzles are formed for dispensing first fluid streams as the first fluid to the substrate, and wherein the second outlet nozzles are formed for dispensing a gas in second fluid streams as the second fluid such that each of the second fluid streams runs at least substantially parallel to at least one of the first fluid streams or each of the second fluid streams converges with at least one of the first fluid streams.

9-11. (canceled)

12. The nozzle arrangement of claim 1,
wherein the nozzle arrangement is in the form of a laminated nozzle assembly formed from sheet-like elements which are areally connected to one another.

13. A system for applying fluids to a substrate, the system comprising:
a distributor head configured to be connected to an actuator and configured to be moved relative to the substrate along a direction of movement; and
at least one nozzle arrangement of claim 1 which is configured to be connected to the distributor head in a mounting region of the distributor head,
wherein the at least one nozzle arrangement is arranged in the mounting region of the distributor head such that the end-side side surface of the main body of the nozzle arrangement is oriented at least substantially perpendicular to the direction of movement of the distributor head, wherein the distributor head moves in the direction of movement when fluids are applied via the first outlet nozzles of the nozzle arrangement.

14. A method for applying fluids to a substrate, the method comprising:
moving a nozzle arrangement according to claim 1 relative to the substrate in a direction of movement; and
dispensing a fluid jet through the first outlet nozzles of the nozzle arrangement during the movement of the nozzle arrangement relative to the substrate.

15. The method of claim 14,
wherein the fluid jets dispensed through the first outlet nozzles are deflected by shaping air dispensed via the second outlet nozzles for creating an omega-shaped pattern of the fluid jet applied to the substrate.

16. The nozzle arrangement of claim 1,
wherein, for each of the first outlet nozzles, at least one of the second outlet nozzles is provided and spaced apart from the first outlet nozzle in the first direction.

17. The nozzle arrangement of claim 16, wherein the first outlet nozzles are formed for dispensing the first fluid at an equal first fluid mass flow rate, wherein the second outlet nozzles are formed for dispensing the second fluid at an equal second fluid mass flow rate.

18. The nozzle arrangement of claim 17, wherein the end-side side surface of the main body includes mutually adjacently arranged third outlet nozzles for the second fluid, the third outlet nozzles formed in a third row extending along the second direction, wherein the first row, with the first outlet nozzles, is arranged between the second and third rows, with the second and third outlet nozzles,
wherein the third outlet nozzles are formed for dispensing the second fluid as a gas at an equal third fluid mass flow rate.

19. The nozzle arrangement of claim 18,
wherein the second and third fluid mass flow rates are equal; or
wherein the second and third fluid mass flow rates are different from one another and vary with respect to time.

20. The nozzle arrangement of claim 18,
wherein, for each of the first outlet nozzles, at least one of the third outlet nozzles is provided and spaced apart from the first outlet nozzle in the first direction.

21. The nozzle arrangement of claim 18, wherein an effective surface of nozzle openings of the second and third outlet nozzles is of an equal size or at least substantially of an equal size.

22. The nozzle arrangement of claim 18, wherein the first outlet nozzles are formed for dispensing the first fluid to the substrate in first fluid streams, and the third outlet nozzles are formed for dispensing pressurized air in third fluid streams such that each of the third fluid streams runs at least substantially parallel to at least one of the first fluid streams or each of the third fluid streams converges with at least one of the first fluid streams.

23. The nozzle arrangement of claim 1, wherein at least one of the first fluid or the second fluid is a thermoplastic adhesive.

24. The nozzle arrangement of claim 1, wherein each of the first outlet nozzles and each of the second outlet nozzles has a nozzle opening with a length of each of the nozzle openings of the first outlet nozzles being longer than a length of each of the nozzle openings of the second outlet nozzles.

25. The nozzle arrangement of claim 1, wherein the second fluid is pressurized air.
